(19) United States
(12) Patent Application Publication
(10) Pub. No.: US 2017/0003851 A1
(43) Pub. Date: Jan. 5, 2017

(54) INTERACTIVE THREE-DIMENSIONAL CUBE ON A DISPLAY AND METHODS OF USE

(71) Applicant: BOOMCLOUD, INC, HIGHLANDS RANCH, CO (US)

(72) Inventors: GEORGE MOORE, HIGHLANDS RANCH, CO (US); TAYLOR ERICKSON, LONE TREE, CO (US)

(21) Appl. No.: 14/919,187

(22) Filed: Oct. 21, 2015

Related U.S. Application Data
(60) Provisional application No. 62/187,456, filed on Jul. 1, 2015.

(51) Int. Cl. G06F 3/0481; G06F 3/0484; G06F 3/0482

(52) U.S. Cl. CPC G06F 3/04815; G06F 3/04817; G06F 3/0482; G06F 3/04842

(57) ABSTRACT

The present application is directed to a computer-implemented method including a step of displaying, on a display, a graphical user interface of a three-dimensional object having a face including a tile. The method also includes a step of receiving, via a network, a selection of the tile of the three-dimensional object. The method also includes a step of modifying, via the processor, three-dimensional object based upon the selected tile. The method further includes the step of displaying, on the display, a panel representative of the selected tile based upon the modification. The present application is also directed to a computer-implemented method for updating social media content.

### CROSS-REFERENCE TO RELATED APPLICATIONS

This application claims priority to U.S. Provisional Application No. 62/187,456, filed Jul. 1, 2015, the disclosure of which is incorporated herein by reference in its entirety.

### FIELD

The present application generally relates to a three-dimensional object on a graphical user interface for sharing content. In particular, the application relates to architectures and methods of sharing social media content via the three-dimensional object.

### BACKGROUND

Social media is the wave of the future. Almost ten percent of the 4 trillion images in existence were taken in 2014. Nearly 300 million images are posted on social media platforms, such as Facebook, daily. In so doing, nearly 4 Exabytes of unique information will be generated this year alone. From a marketing standpoint, organization of social media content will be critical for its survival and to flourish.

Social media companies generally offer specific types of services to users. For example, these services may include sharing general purpose communications, video content, real-time news, thoughts, photos, visual stories, and preferences. These services, however, lack sufficient functionality to create, organize and share interests in a user-friendly visual platform.

Most social media platforms are two-dimensional. Namely, preference information and shareable content in the platforms are typically displayed in a flat, HTML format, or alternatively in a channel scrolling format. This format makes it difficult to collectively view all the preference information and shareable content preferences in a holistic fashion.

Some social media platforms include an interest graph including a collection of non-prioritized likes, interests and preferences. While there certainly is utility in using interest graphs, they do not provide preference information and content data in a user-friendly and engaging interface.

In view of increased responsibilities, users have less time to view all of their available social media content. What is desired in the art is a platform that maximizes the amount of social media content a user can view in the shortest amount of time.

What is also desired in the art is a touch-enabled platform whereby users can update, organize and share visual social media content.

### SUMMARY

This summary is provided to introduce a selection of concepts in a simplified form that are further described below in the Detailed Description. This Summary is not intended to limit the scope of the claimed subject matter. The foregoing needs are met, to a great extent, by the present application directed to an interactive three-dimensional cube on a display and methods of use.

According to an aspect of the application, a computer-implemented method of using a three-dimensional objection on a display is described. The method includes a step of displaying, on a display, a graphical user interface of a three-dimensional object having a face including a tile. The method also includes a step of receiving, via a network, a selection of the tile of the three-dimensional object. The method also includes a step of modifying, via the processor, three-dimensional object based upon the selected tile. The method further includes the step of displaying, on the display, a panel representative of the selected tile based upon the modification. In one embodiment, the three-dimensional object is a cube. In another embodiment, the face of the cube includes plural tiles. In yet another embodiment, the panel displays an image selected from a picture, a webpage, another three-dimensional object, and combinations thereof.

According to another aspect of the application a non-transitory computer readable medium is described. The non-transitory computer readable medium includes executable instructions that are executed by a computer including a processor and a display. The executable instructions cause the computer to display, on the display, a graphical user interface of a three-dimensional cube exhibiting social media content, the three-dimensional cube having a face including a tile. The computer executable instructions also cause the computer to receive, via the graphical user interface, a selection of the tile including an aspect of the social media content. The computer executable instructions also cause the computer to modify, via the processor, the three-dimensional cube based upon the selected tile. According to an embodiment, the computer executable instructions cause the computer to display, on the display, a panel representative of the selected tile after the modifying step.

According to yet another aspect of the application a computer-implemented method is for updating social media content is described. The method includes a step of providing, on a display, a graphical user interface of a three-dimensional object exhibiting the social media content of a user on a network. The method also includes a step of receiving, via the graphical user interface, a selection by the user of information associated with a second user on the network. The method also includes a step of modifying the three-dimensional object to include the information on a tile of the three-dimensional object. Further, the method includes a step of displaying the modified three-dimensional object including the information on the tile. In an embodiment, the method also includes a step of adding the information of the second user to a profile page of the user before the modifying step. In another embodiment, the method includes a step of sharing the modified three-dimensional object with the network. According to another embodiment, the social media content and the information are selected from pictures, webpages, videos, another three-dimensional object and combinations thereof. In yet another embodiment, the method includes the steps of detecting an input on the graphical user interface displaying a first panel associated with the tile of the modified three-dimensional object panel, and subsequently updating the modified three-dimensional object to display a second panel associated with a second tile of the three-dimensional object.

### DESCRIPTION OF THE DRAWINGS

In order to facilitate a more robust understanding of the application, reference is now made to the accompanying drawings, in which like elements are referenced with like numerals. These drawings should not be construed to limit the application and are intended only to be illustrative.

FIG. 1A illustrates a machine-to machine (M2M) or IoT communication system according to an embodiment of the application.

FIG. 1B illustrates the application of a M2M service platform according to an embodiment of the application.

FIG. 1C illustrates the application of a system diagram of an example M2M device according to an embodiment of the application.

FIG. 1D illustrates the application of a block diagram of an exemplary computing system according to an embodiment of the application.

FIG. 2A illustrates a three-dimensional cube presentation on a mobile device according to an embodiment of the application.

FIG. 2B illustrates GUI of a three-dimensional cube presentation on display of a mobile device according to another embodiment of the application.

FIG. 3A illustrates a 3×3 three-dimensional cube according to an embodiment of the application.

FIG. 3B illustrates a 3×3 three-dimensional cube according to another embodiment of the application.

FIG. 3C illustrates multiple social media tags on a 3×3 three-dimensional cube according to an embodiment of the application.

FIG. 4A illustrates a tile of a face of a cube according to an embodiment of the application.

FIG. 4B illustrates a panel associated with the tile shown in FIG. 4A.

FIG. 5A illustrates a GUI on the display of a mobile device with a panel according to an embodiment of the application.

FIG. 5B illustrates a GUI on a display of a mobile device with a search icon according to an embodiment of the application.

FIG. 6A illustrates a GUI on a display of a mobile device for updates according to an embodiment of the application.

FIG. 6B illustrates a GUI on a display of a mobile device with a user following page according to an embodiment of the application.

FIG. 7A illustrates a GUI on a display of a mobile device with a profile page according to an embodiment of the application.

FIG. 7B a GUI on a display of a mobile device with a settings page according to an embodiment of the application.

### DETAILED DESCRIPTION

A detailed description of the illustrative embodiments will be discussed in reference to various figures, embodiments and aspects herein. Although this description provides detailed examples of possible implementations, it should be understood that the details are intended to be examples and thus do not limit the scope of the application.

Reference in this specification to “one embodiment,” “an embodiment,” “one or more embodiments,” “an aspect” or the like means that a particular feature, structure, or characteristic described in connection with the embodiment is included in at least one embodiment of the disclosure. Moreover, the term “embodiment” in various places in the specification is not necessarily referring to the same embodiment. That is, various features are described which may be exhibited by some embodiments and not by the other.

Generally, the present application is directed to a three-dimensional social media platform. In one aspect, the application employs social media services in a three-dimensional, touch-enabled graphical interface. By so doing, users are able to efficiently organize, monitor and transmit information to others.

In an embodiment, the social media platform includes a three-dimensional object that allows for quick and easy visualization/presentation of multiple ideas. The format also allows for a user to quickly organize and display their preferences. For example, the preferences may include but are not limited to media, sports, channels, shows, videos, finances, activities, interests, friends, music, books, art and movies. The social media platform also allows a user to create a somatic and emotional link through videos, music, and visual presentations of the aforementioned preferences. The three-dimensional social media platform allows users to quickly determine social and interest graphs of others.

The application can be used by individuals and companies to create, organize, showcase and share passions and interests in a syndicated three-dimensional, visual platform. The platform may be employed for search indexing, three-dimensional taxonomy, three-dimensional data visualization and business intelligence. The platform may further be adopted for presenting data in a three-dimensional interface in technologies such as real estate and cable programming.

The present application is in the technical field of computer, smart phone, cable, satellite, tablet, browser and program guide visualization. More specifically, the present application is in the technical field of data and preference visualization. In an exemplary embodiment, the three-dimensional object on the social media platform is a cube. In another exemplary embodiment, the social media platform is provided on a mobile device.

According to further aspect of the application, the presentation and data preference format may be employed as a form factor for online, browser, IPTV, satellite, cable programming guides. Each side represents a particular or specific interest (sports, movies, news, education, religious, music, art, family, comedy, etc.).

The presentation and data preference format may also be used for utilizing images and image taxonomy in order to build a search friendly online profile for indexing by search engines for presentation within a Search Engine Result Page (SERP). In one embodiment, it may also be used to utilize images and image taxonomy to determine degrees of interest in a social media profile. In another embodiment, it may further be utilized as a 3D virtual cube in an online service to visually depict an individual user in an online community.

According to yet another embodiment, it may be utilized as a 3D cube visualization to depict information in an online community. This information could depict likes and interest of an individual in a community. The 3D cube visualization could depict groups within a community of people of common interest. The 3D cube visualization could depict information in a category or related taxonomical system.

In a further embodiment, the presentation and data preference format may also be used to build a 3D cube visualization of a profile for an individual, social media, group, community or body of information. The 3D cube(s) may also depict a profile with alternate visualizations that are virtual depictions of knowledge, interest, family, likes, dislikes, and friends.

According to another embodiment, the presentation and data preference format may also be used for personal data and preference visualization. Namely, it utilizes personal data and preferences on a 3D cube form factor made up of images, pictures, text, and videos and being able to connect people based on those preferences and likes. In taking these personal data and conducting a search within social networks, users may build connections and communities based on “common interests.”

According to another embodiment, the presentation and data preference may be used for brand advertising. Here, the cubes are utilized as a form factor for brand advertising and promotions. Fly by ads and sponsorship cube environments are envisaged.

According to the concept of 4.7 degrees of separation, the cubes may be employed to define proximity of relationships based on common interests. The cubes may also be employed to cue-up relevant videos and advertisements.

In yet even a further embodiment, a group of cubes are linked together to define, articulate, and visually show social causes, promotions, & events according to a cube aggregation display. Moreover, a series of cubes to demonstrate or show a series of promotions, shows, entertainment, & events may be utilized.

The cubes may also be used for giveways, promotions, discounts and gift giveaways. For example, by grabbing a passing cube, a user could win a prize, such as for example, a McDonald's Big Mac.

In one embodiment, the cubes may be employed for travel. For example, users may travel from to other countries and environments (e.g., Sci-Fi, Gaming, Entertainment, News, Sports, Business, Communities, Education, Health/wellness, etc.) and explore those environments. This may include submersing oneself in a cube from Africa or China in order to learn about the culture.

The cubes may also be employed to define a set of creative or expertise energy/gravity. In other words, based on your significance, what you know, and all your cubes that have been voted best by peers, a user can create GRAVITY and pull more people into their universe. This may include a particle dynamics engine, a gaming engine, and a social network dynamics engine.

The cube may also be employed for business intelligence. Here, the cubes are utilized in aggregation to define trends, movements, preferences, and shifts in product or service popularity.

The inside of cubes may be utilized to create a hologram of data and information. The cube may be a public cube or alternatively a private cube with a password.

The application may also include somatic cubes. These cubes allow a person to demonstrate emotive icons, feelings, and images. Happy, sad, tears, laughter, joy, surprise, excitement, anticipation, fear, sexual intensity, anger, defiance, passion, etc. thru the use of colors, hues, sounds, flashes.

Cubes may also include music and tones. The cubes may be employed to define a user with music and rotational sounds from cubes rotating. Cubes may also be used as a mechanism to promote entertainment games, social cause games and game promotions. The cubes may also be used to define a user's expertise to share with people and become a Global Authenticator or an expert in a particular field of interest, e.g., cube curator.

According to yet even a further embodiment, the cubes may define a user's country and city. Using a global earth view of a rotating globe, cubes are suspended above the globe with your profile picture and flag of your country to identify your cube's origin.

The cubes may also be includes as a rubric cube. Here, a user may generate fun puzzles and games and secret messages that encrypt with certain rotation and decrypts with set number of rotations.

In yet a further aspect, the cubes may also be used for video conferencing. Each panel on the cube may represent a place holder for a video session. Accordingly, nine concurrent video conferences may occur based on the nine panels of the cube.

### General Architecture

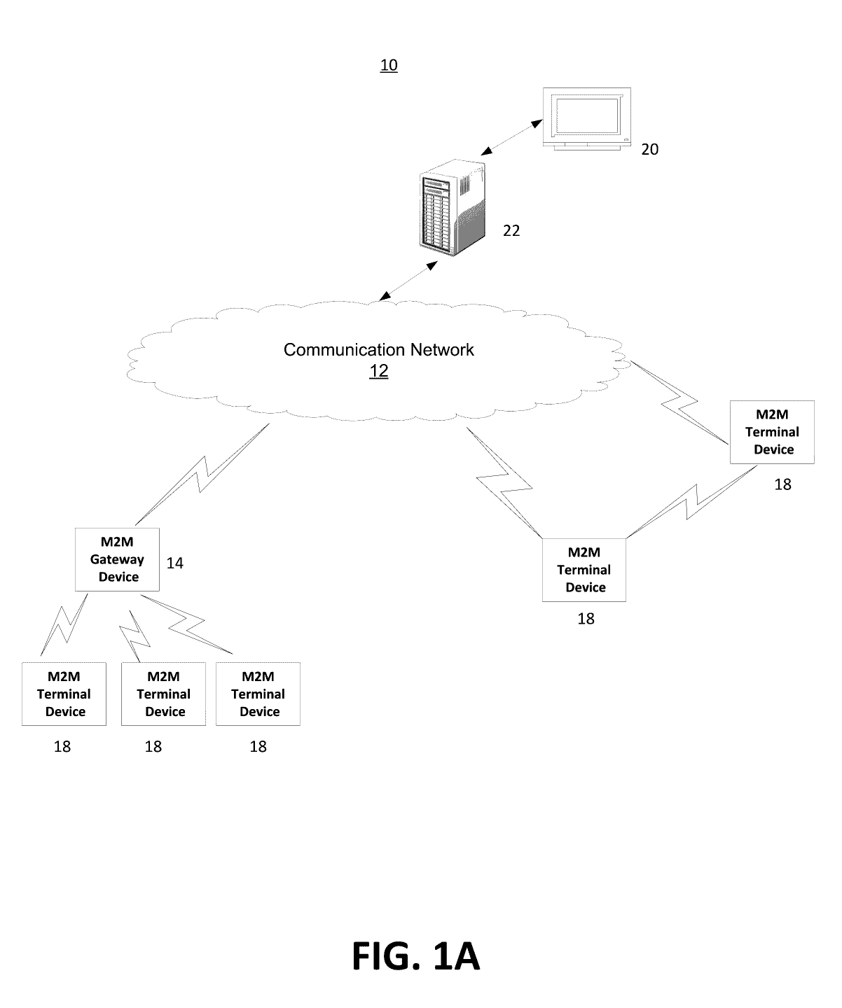

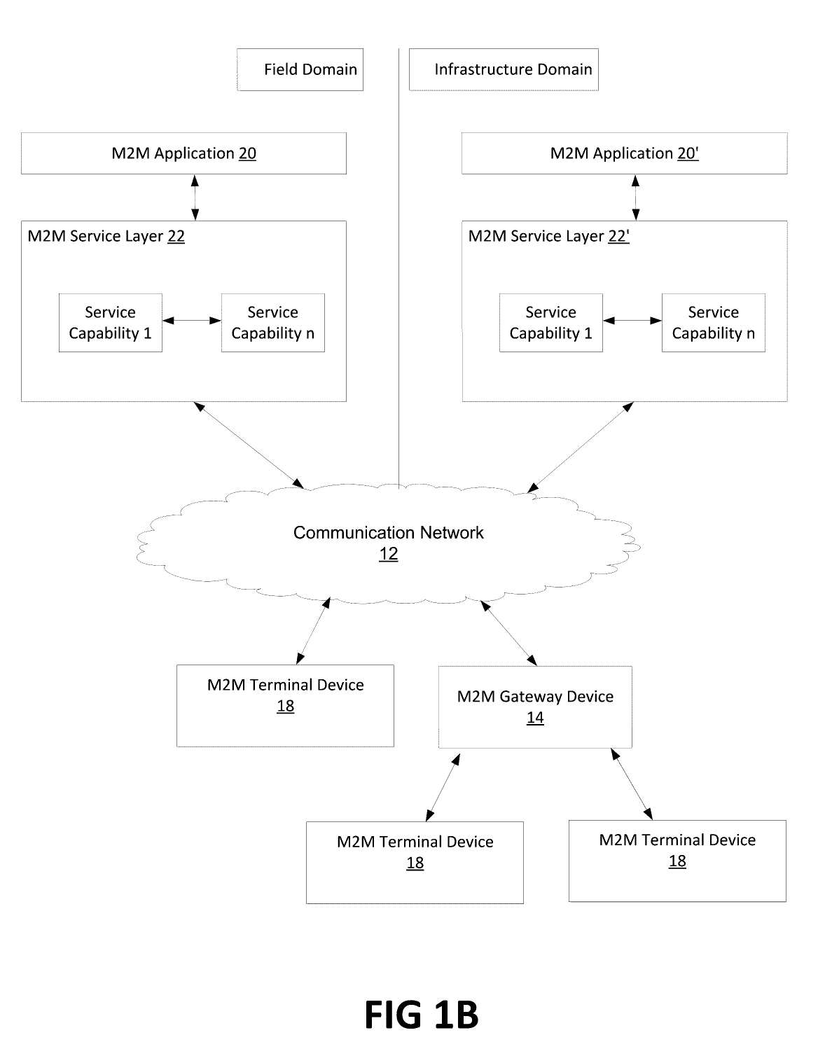

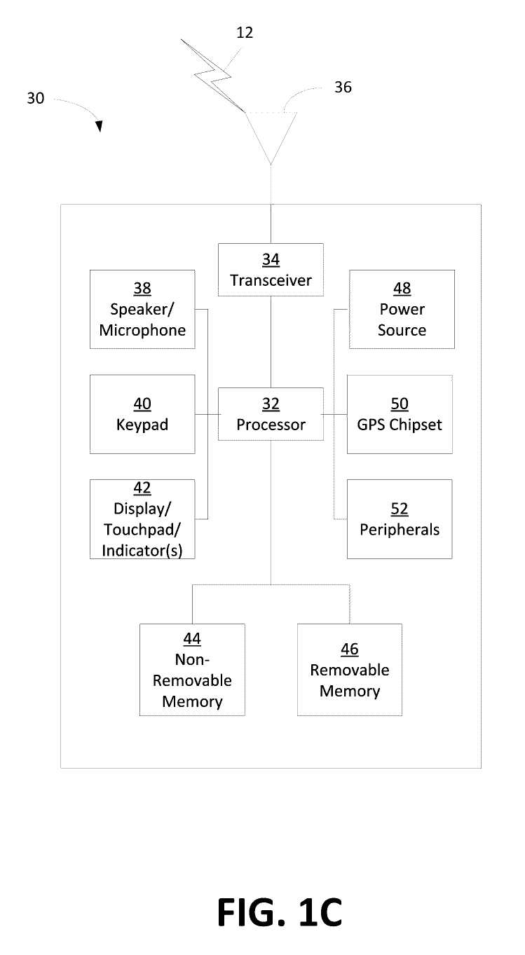

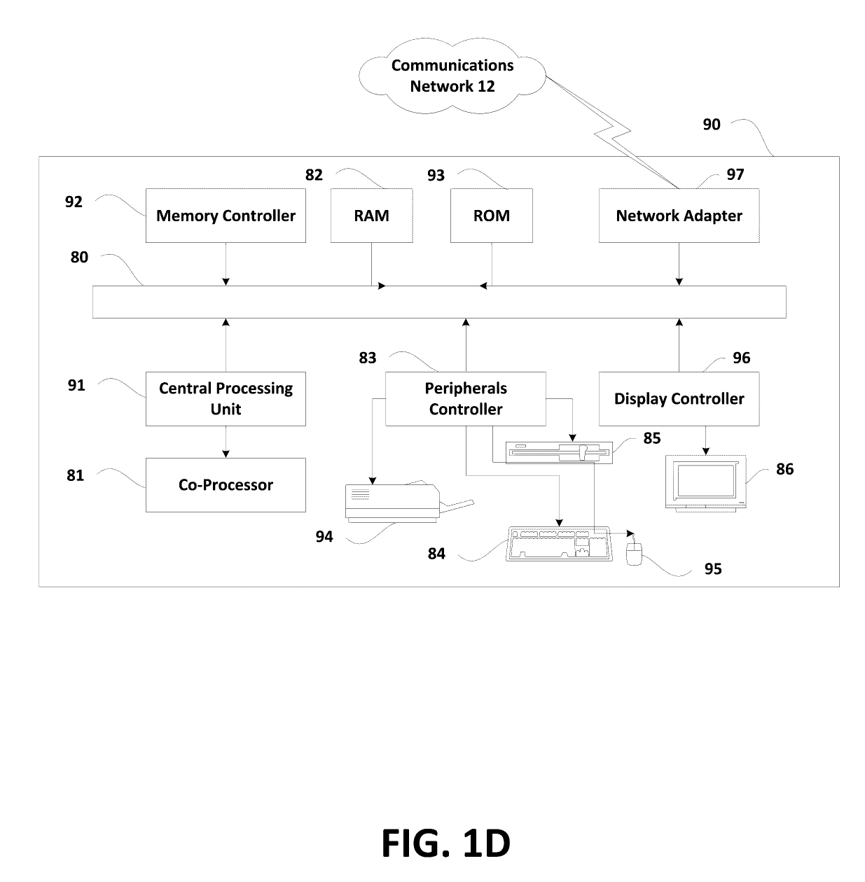

FIG. 1A is a diagram of an example machine-to machine (M2M), Internet of Things (IoT), or Web of Things (WoT) communication system 10 in which one or more disclosed embodiments may be implemented. Generally, M2M technologies provide building blocks for the IoT/WoT, and any M2M device, gateway or service platform may be a component of the IoT/WoT as well as an IoT/WoT service layer, etc.

As shown in FIG. 1A, the M2M/IoT/WoT communication system 10 includes a communication network 12. The communication network 12 may be a fixed network, e.g., Ethernet, Fiber, ISDN, PLC, or the like or a wireless network, e.g., WLAN, cellular, or the like, or a network of heterogeneous networks. For example, the communication network 12 may comprise of multiple access networks that provides content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a satellite network, a home network, or an enterprise network for example.

As shown in FIG. 1A, the M2M/IoT/WoT communication system 10 may include the Infrastructure Domain and the Field Domain. The Infrastructure Domain refers to the network side of the end-to-end M2M deployment, and the Field Domain refers to the area networks, usually behind an M2M gateway. The Field Domain includes M2M gateways 14, such as a Service Capability Server (SCS) with a proxy, and terminal devices 18, such as UE devices. In an embodiment, the UE devices can be mobile phones, such as for example, 3G and 4G smartphones. It will be appreciated that any number of M2M gateway devices 14 and M2M terminal devices 18 may be included in the M2M/IoT/WoT communication system 10 as desired. Each of the M2M gateway devices 14 and M2M terminal devices 18 are configured to transmit and receive signals via the communication network 12 or direct radio link. The M2M gateway device 14 allows wireless M2M devices, e.g., cellular and non-cellular as well as fixed network M2M devices, e.g., PLC, to communicate either through operator networks, such as the communication network 12 or direct radio link. For example, the M2M devices 18 may collect data and send the data, via the communication network 12 or direct radio link, to an M2M application 20 or M2M devices 18. The M2M devices 18 may also receive data from the M2M application 20 or an M2M device 18. Further, data and signals may be sent to and received from the M2M application 20 via an M2M service layer 22, as described below. M2M devices 18 and gateways 14 may communicate via various networks including, cellular, WLAN, WPAN, e.g., Zigbee, 6LoWPAN, Bluetooth, direct radio link, and wireline for example.

Referring to FIG. 1B, the illustrated M2M service layer 22 in the field domain provides services for the M2M application 20, M2M gateway devices 14, and M2M terminal devices 18 and the communication network 12. It will be understood that the M2M service layer 22 may communicate with any number of M2M applications, M2M gateway devices 14, such as for example transit CSEs, M2M terminal devices 18, such as host CSEs and Originators, as well as communication networks 12 as desired. The M2M service layer 22 may be implemented by one or more servers, computers, or the like. The M2M service layer 22 provides service capabilities that apply to M2M terminal devices 18, M2M gateway devices 14 and M2M applications 20. The functions of the M2M service layer 22 may be implemented in a variety of ways. For example, the M2M service layer 22 could be implemented in a web server, in the cellular core network, in the cloud, etc.

Similar to the illustrated M2M service layer 22, there is the M2M service layer 22′ in the Infrastructure Domain. M2M service layer 22′ provides services for the M2M application 20′ and the underlying communication network 12 in the infrastructure domain. M2M service layer 22′ also provides services for the M2M gateway devices 14 and M2M terminal devices 18 in the field domain. It will be understood that the M2M service layer 22′ may communicate with any number of M2M applications, M2M gateway devices and M2M terminal devices. The M2M service layer 22′ may interact with a service layer by a different service provider. The M2M service layer 22′ may be implemented by one or more servers, computers, virtual machines, e.g., cloud/compute/storage farms, etc., or the like.

Referring also to FIG. 1B, the M2M service layer 22 and 22′ provide a core set of service delivery capabilities that diverse applications and verticals can leverage. These service capabilities enable M2M applications 20 and 20′ to interact with devices and perform functions such as data collection, data analysis, device management, security, billing, service/device discovery etc. Essentially, these service capabilities free the applications of the burden of implementing these functionalities, thus simplifying application development and reducing cost and time to market. The service layer 22 and 22′ also enables M2M applications 20 and 20′ to communicate through various networks 12 and 12′ in connection with the services that the service layer 22 and 22′ provide.

The M2M applications 20 and 20′ may include applications in various industries such as, without limitation, social media, marketing, transportation, health and wellness, connected home, energy management, asset tracking, and security and surveillance. Moreover, the M2M service layer may also be configured to interface with other devices such as UEs, SCSs and MMEs as discussed in this application and illustrated in the figures.

The service layer is a software middleware layer that supports value-added service capabilities through a set of Application Programming Interfaces (APIs) and underlying networking interfaces. ETSI M2M's service layer is referred to as the Service Capability Layer (SCL). The SCL may be implemented within an M2M device (where it is referred to as a device SCL (DSCL)), a gateway (where it is referred to as a gateway SCL (GSCL)) and/or a network node (where it is referred to as a network SCL (NSCL)). The one M2M service layer supports a set of Common Service Functions (CSFs), e.g., service capabilities. An instantiation of a set of one or more particular types of CSFs is referred to as a Common Services Entity (CSE), such as a SCS which may be hosted on different types of network nodes, e.g., infrastructure node, middle node, application-specific node

FIG. 1C is a system diagram of an example M2M device 30, such as a M2M terminal device 18 or an M2M gateway device 14 for example. As shown in FIG. 1C, the M2M device 30 may include a processor 32, a transceiver 34, a transmit/receive element 36, a speaker/microphone 38, a keypad 40, a display/touchpad/indicator(s) 42, non-removable non-transitory memory 44, removable non-transitory memory 46, a power source 48, a global positioning system (GPS) chipset 50, and other peripherals 52. It will be appreciated that the M2M device 40 may include any sub-combination of the foregoing elements while remaining consistent with an embodiment. The M2M device 30 may also be employed with other devices, including for example originators and hosting/transit CSEs as described in this application and as illustrated in the figures.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 32 may perform signal coding, data processing, power control, input/output processing, and/or any other functionality that enables the M2M device 30 to operate in a wireless environment. The processor 32 may be coupled to the transceiver 34, which may be coupled to the transmit/receive element 36. While FIG. 1C depicts the processor 32 and the transceiver 34 as separate components, it will be appreciated that the processor 32 and the transceiver 34 may be integrated together in an electronic package or chip. The processor 32 may perform application-layer programs, e.g., browsers, and/or radio access-layer (RAN) programs and/or communications. The processor 32 may perform security operations such as authentication, security key agreement, and/or cryptographic operations, such as at the access-layer and/or application layer for example.

The transmit/receive element 36 may be configured to transmit signals to, or receive signals from, an M2M service platform 22. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 1C as a single element, the M2M device 30 may include any number of transmit/receive elements 36. More specifically, the M2M device 30 may employ MIMO technology. Thus, in an embodiment, the M2M device 30 may include two or more transmit/receive elements 36, e.g., multiple antennas, for transmitting and receiving wireless signals.

The transceiver 34 may be configured to modulate the signals that are to be transmitted by the transmit/receive element 36 and to demodulate the signals that are received by the transmit/receive element 36. As noted above, the M2M device 30 may have multi-mode capabilities. Thus, the transceiver 34 may include multiple transceivers for enabling the M2M device 30 to communicate via multiple RATs, such as UTRA and IEEE 802.11, for example.

The processor 32 may access information from, and store data in, any type of suitable non-transitory memory, such as the non-removable memory 44 and/or the removable memory 46. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the M2M device 30, such as on a server or a home computer.

The processor 32 may receive power from the power source 48, and may be configured to distribute and/or control the power to the other components in the M2M device 30. The power source 48 may be any suitable device for powering the M2M device 30. For example, the power source 48 may include one or more dry cell batteries, e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information, e.g., longitude and latitude, regarding the current location of the M2M device 30. It will be appreciated that the M2M device 30 may acquire location information by way of any suitable location-determination method while remaining consistent with an embodiment.

The processor 32 may further be coupled to other peripherals 52, which may include one or more software and/or hardware modules that provide additional features, functionality and/or wired or wireless connectivity. For example, the peripherals 52 may include an accelerometer, an e-compass, a satellite transceiver, a sensor, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1D is a block diagram of an exemplary computing system 90 on which, for example, the M2M service platform 22 of FIG. 1A and FIG. 1B may be implemented. Computing system 90 may comprise a computer or server and may be controlled primarily by computer readable instructions, which may be in the form of software, wherever, or by whatever means such software is stored or accessed. Such computer readable instructions may be executed within central processing unit (CPU) 91 to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91 that performs additional functions or assists CPU 91. CPU 91 and/or coprocessor 81 may receive, generate, and process data related to the disclosed systems and methods for embedded semantic naming, such as queries for sensory data with embedded semantic names.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memory devices coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. This may include, for example, discovery results for multi-hop discovery, conditional discovery and hosting CSE redirect. Display 86 may be implemented with a CRT-based video display, an LCD-based flat-panel display, gas plasma-based flat-panel display, or a touch-panel. Display controller 96 includes electronic components required to generate a video signal that is sent to display 86. Display 86, may display sensory data in files or folders using embedded semantics names. Further, computing system 90 may contain network adaptor 97 that may be used to connect computing system 90 to an external communications network, such as network 12 of FIG. 1A and FIG. 1B.

According to a first aspect of the application, a computer-implemented social media platform is described. The social media platform is displayed on a graphical user interface 42 of a device as illustrated in FIG. 1A. The social media platform includes three main pages. These include a Cube Cast page, an Updates page, and a Profile page. Each will be discussed below.

A first page is for a Cube Cast. This page includes a 3-D object, panel views and sharing features of 3D objects and panel views.

A second page is for Updates. This page includes status updates, activity of who the user is following and activity of who is following the user.

A third page is for the User Profile. Here, the user can modify their profile, check metrics of followers and visitors, review/update their panel views and also share images or cube casts.

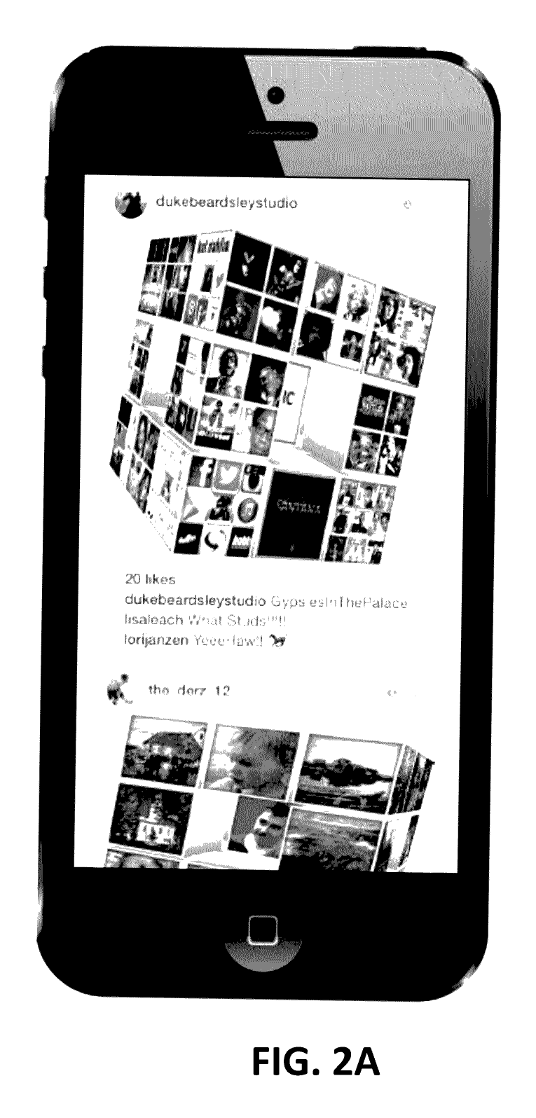

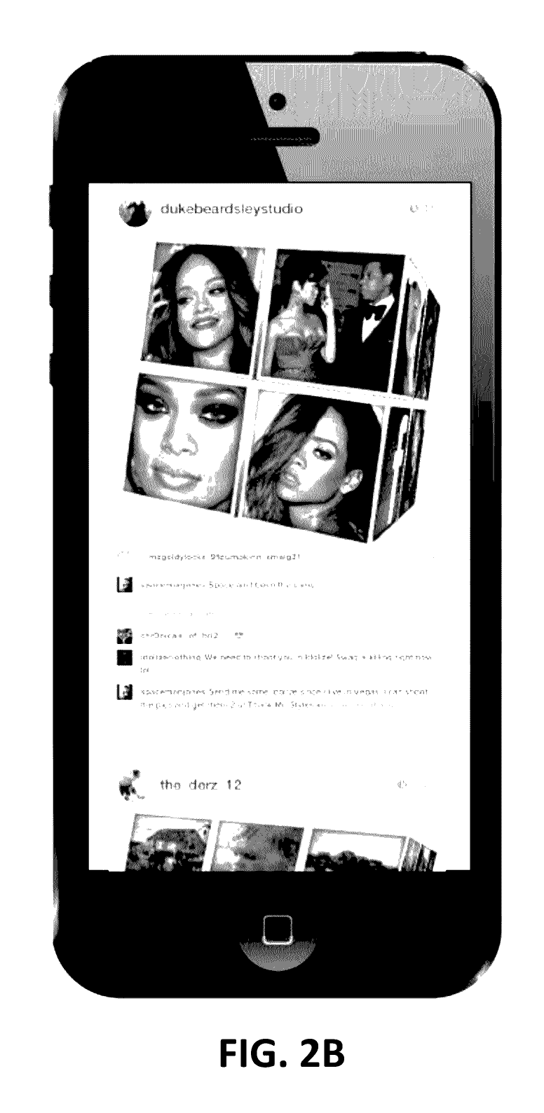

The graphical user interface (GUI) is provided on a display of a device, such as for example, a smartphone, as illustrated in FIGS. 2A-B. As depicted, the GUI includes a three-dimensional object 200. According to an embodiment, the three-dimensional object is a cube. However, the three-dimensional object is envisaged to be any shape capable of being displayed in the GUI.

In the embodiment shown in FIG. 2A, a three-dimensional object 200 is depicted on one of the main pages of the social media platform. The three-dimensional object can be customized by the user to illustrate different aspects of their life, hobbies, and accomplishments. The cube cast can also be used for business purposes. For example, a user who is trying to market their business to potential customers may include plural images on their cube cast highlighting different areas of their practice. For example, one entire face, or perhaps a tile in a face can highlight the business owner's biography. Another face or a tile in the face can highlight past achievement. Another face or tile in the face can highlight current customers, if not proprietary. One or more faces or tiles in the face can highlight the services they offer. As shown, the cubes are spaced slightly apart from one another.

As shown in FIG. 2A, the object 200 is a 3×3 cube including twenty-one (21) individual cubes. As will be explained in more detailed below, each individual cube includes plural faces, e.g., 6, each including one or more tiles. The cubes are held together in a cube construct that moves and behaves as a single cube. Alternatively, each of the cubes may behave as independent cubes. FIG. 2B illustrates a cube cast 200 of a 2×2 cube. Here, there are eight (8) individual cubes. Each cube has 6 faces. While each face has a single tile in this embodiment, other embodiments may include plural tiles in a single face.

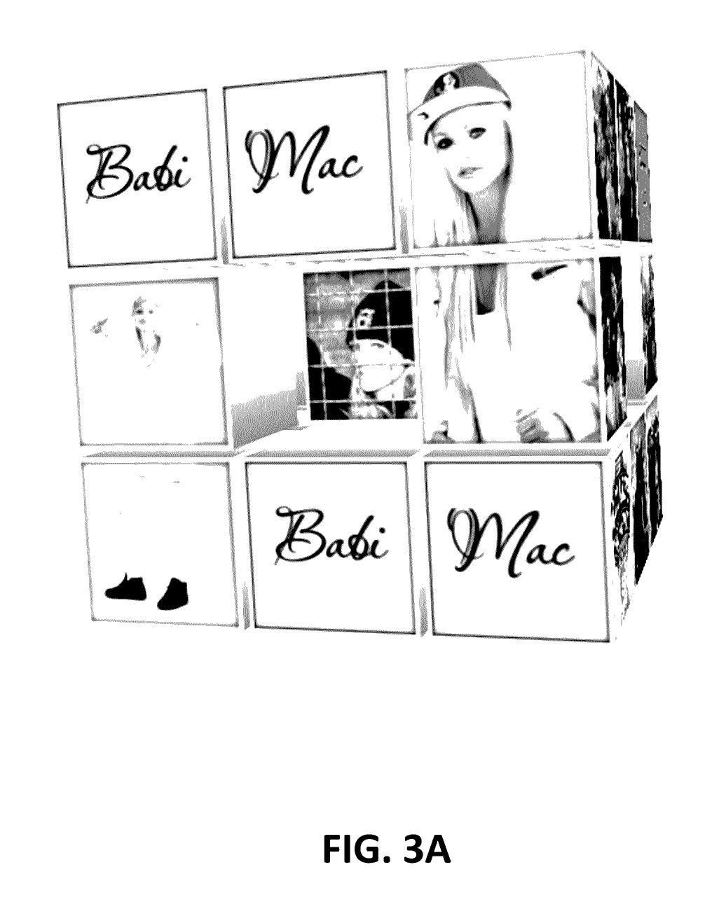

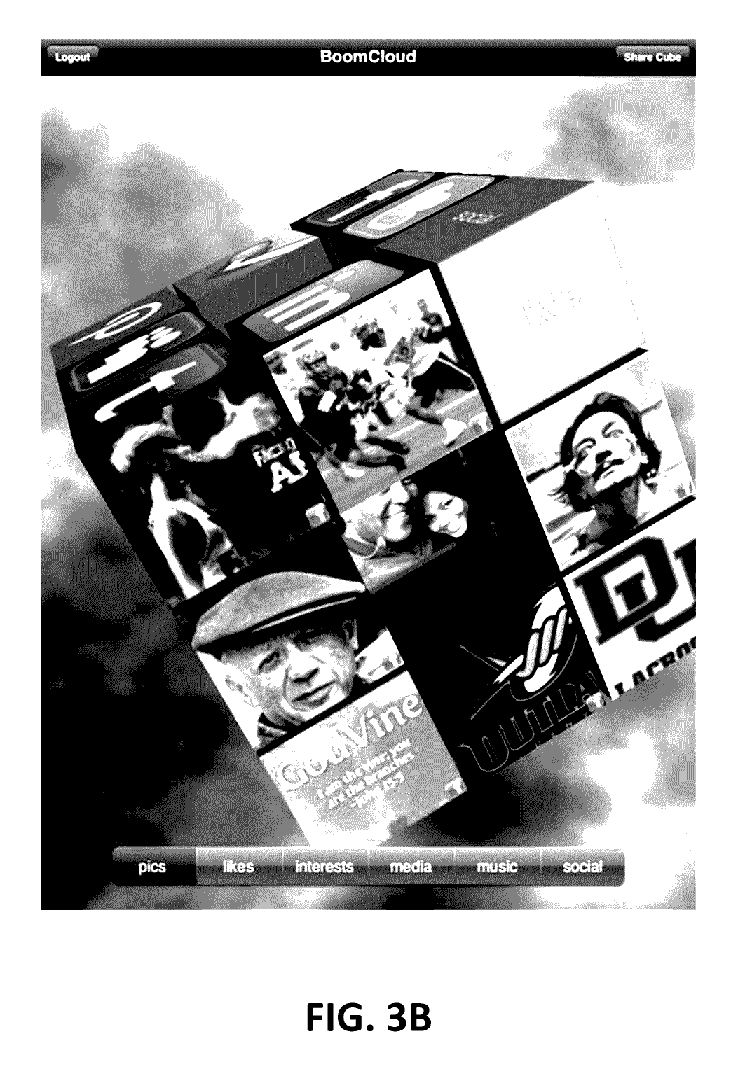

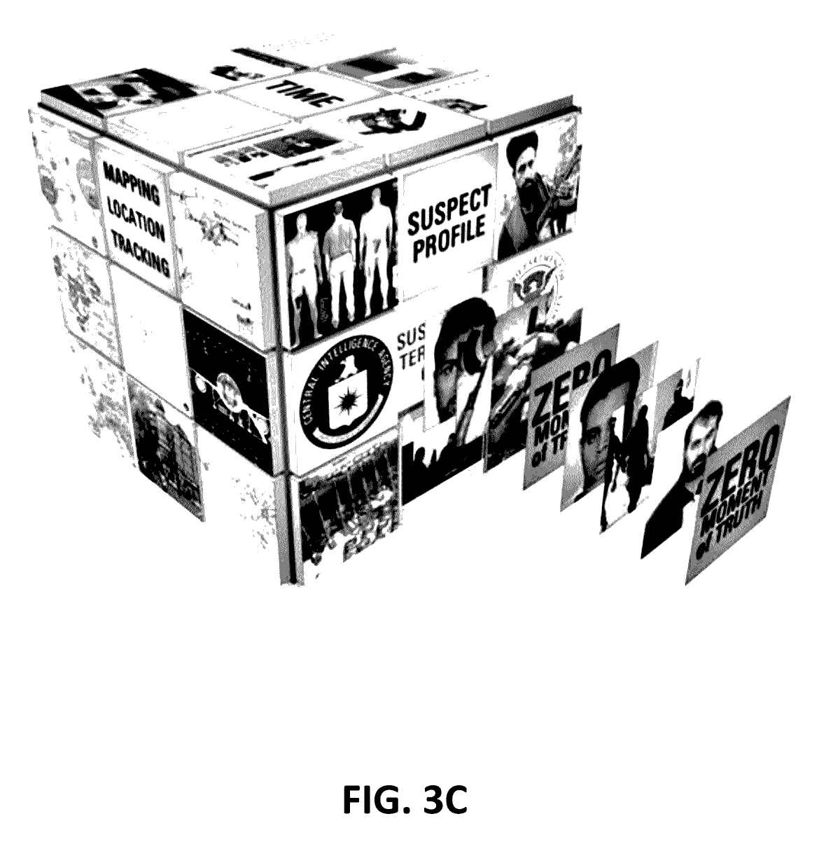

Another representation of a cube cast 200 is the 3×3 cube illustrated in FIG. 3A. As shown in FIG. 3A, the space between each of the 21 cubes is of a predetermined width. Each of the cubes includes a border which frames the image. The border may include a slight bevel for enhancing the image's appearance. As the 3×3 cube rotates, as a whole, it uses perspective rendering instead of isomeric rendering. 1×1 and 2×2 cubes are also envisaged according this application.

According to an embodiment, touching or clicking the predetermined space, e.g., white space, between adjacent cubes causes a particular cube to rotate. Since each of the 21 cubes has six 6 faces, which are also known as tiles, the total number of tiles for a 3×3 cube is 126.

Next, the application receives a user selection of a particular tile. The user may click or touch the white space to see additional tiles of a particular cube. The cube can rotate in a fixed manner, left to right and then up and down. Alternatively, the cube can rotate in a manner depending upon where the user touches or clicks on the white space. For example, if the user touches a left corner of the white space, the cube will turn. If the user touches an upper corner of the white space, the cube will turn upward.

In an embodiment, a face of the cube may cycle through one or more images. This may be the case, for example, with advertising of a product or service. Namely, more than one image may be necessary to convey the intended message of an advertisement. In another other embodiment, plural faces may collectively cycle through images. They cycle of images me be grouped or ungrouped. Alternatively, a tile of a face may cycle through images. In a further embodiment, one but not all tiles of a face may cycle through images.

According to another embodiment as shown in FIG. 3B, a 3D cube displays data in many panels. Each panel or side identifies particular and/or specific interests, whether it is music, art, shows, videos, programs, sports teams, artists, people, places, things, etc. The data is then used to help people quickly see things a user is interested in. In addition, the tags from each image, icon, video, picture, logo, and/or text are used to match other people with like and similar interests. The 3D cube can also be used as a business card, resume, introduction profile, interest graph, or social graph.

FIG. 3C illustrates multiple social media tags that aggregate all your preferred social media on your cube. These tags can be used to access your accounts, share information and data across all your social media utilizing your master cube.

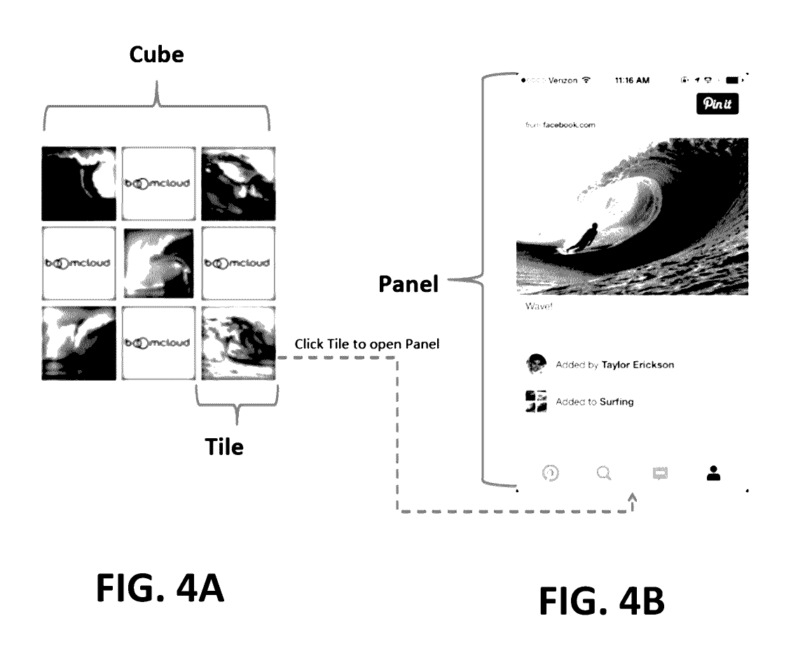

According to another embodiment as shown in FIG. 4A, clicking or touching a specific tile 410, such as for example the bottom left tile 410 of the cube 400, modifies the representation of the three-dimensional object on the display. Namely, the modification opens a panel 420 of the selected tile as shown in FIG. 4B. The panel 420 includes one or more options for a user to explore. For example the image 421 on the panel 420 may be a larger image of the image displayed on the tile 410. This includes but is not limited to a picture, a webpage, a Cube cast.

For example, when the user clicks on the tile to open a panel, it opens to display a pic or a resulting web page associated with the cube tile 410, or a resulting video associated with the cube tile 410. The website associated with the cube tile 410 may be a professional website or a personal web site associated with the user. The video associated with the cube tile 410 may be a professional video or a personal video associated with the user

When the user is viewing a panel 420 associated with a tile 410, he or she may view other panels associated with other tiles of the 3D cube by swiping horizontally across the GUI. By so doing, the user does not have to exit the panel view. In the panel view, users are able to like pics or 3D cubes. Users are also able to add comments beneath pics or cubes. The pics or cubes may be associated with the user or other users. Further, the user may be able to Boom the pic or 3D cube. Booming means adding the pic, cube or the entire 3D cube to the user's profile. The boomed pic or cube can be edited and reposted.

As shown in FIG. 4B, the image 421 is a picture that was uploaded by the user. The comments beneath the image 422 indicate who added the image in addition to the location. The location may include, for example, the tile or an individual cube of the three-dimensional cube.

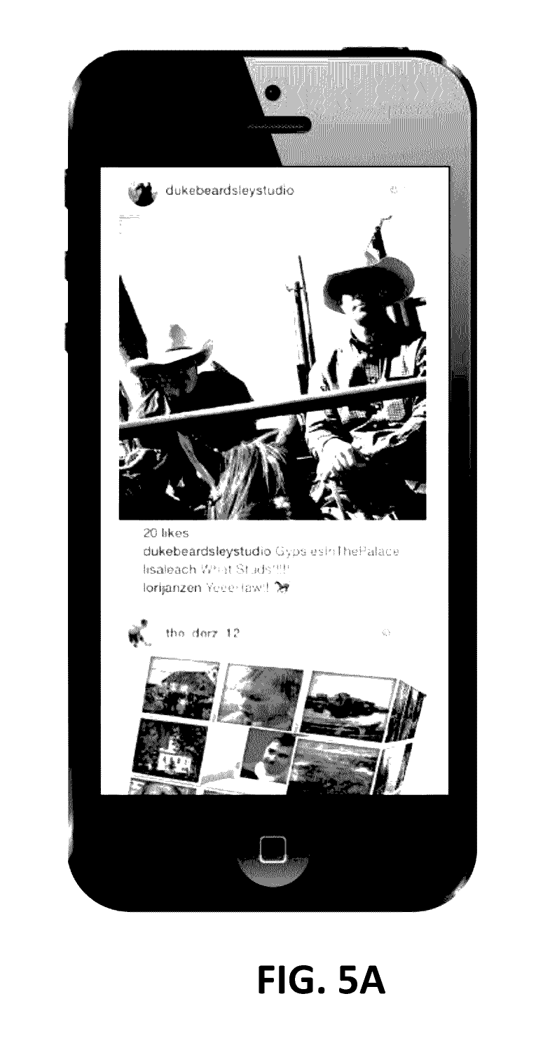

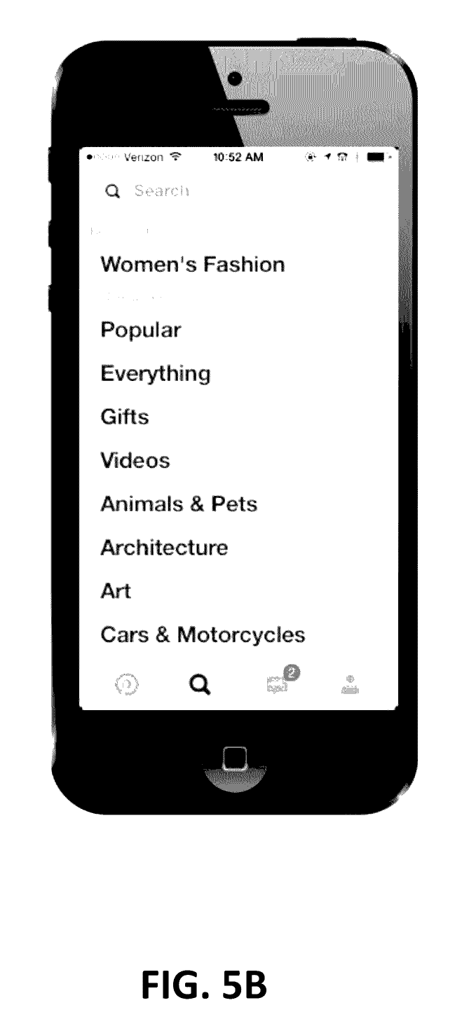

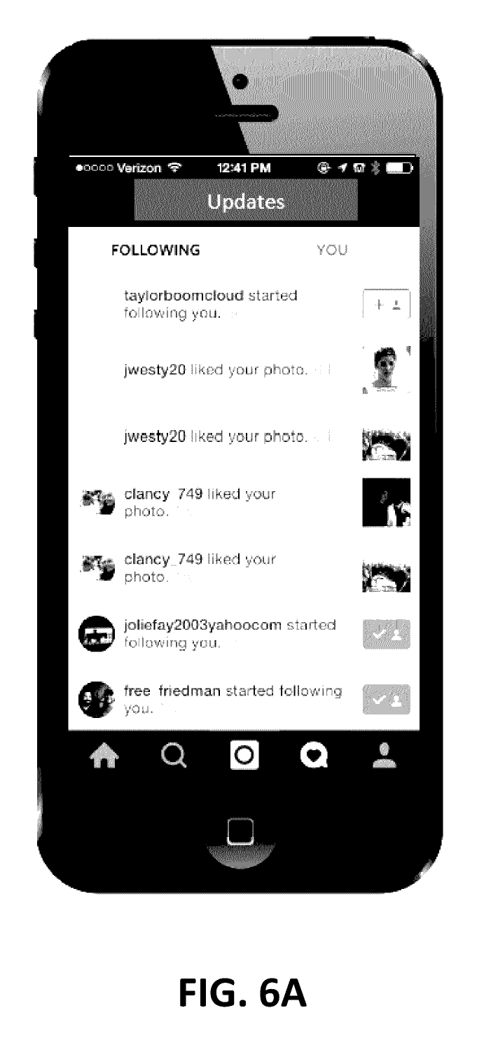

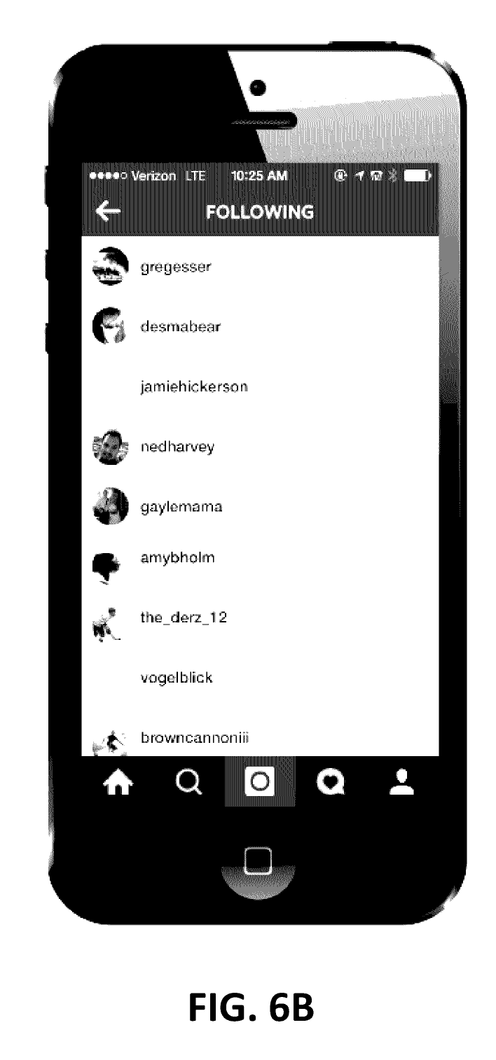

According to another embodiment as shown in FIG. 5A, the GUI on the display may be a panel with a pic. Just below the pic is a cube cast. The cube cast is a collection of panels from people and interest that the user follows. When the person being followed updates their status or adds a new pic, it is casted onto the user's cube. The pics can be casted in one or more ways as commonly known in the art. In addition, the user can customize when they wish to see updates. For example, the user may wish to set a one hour limit before the social platform updates the image. In doing so, the user's battery-life of their device can be preserved.

In another embodiment, the user can add a pic directly to an individual cube. To do so, the selects and opens the tile on the cube where the pic is desired. An option titled, ‘Add a pic to the cube’ is presented. The pic can be added in many ways including but not limited to taking a pic, selecting from the camera roll, or selecting from pics in the user's Profile.

Alternatively, a user can add a new picture to a panel to the Cube Cast page of the social media platform, the user can open the camera tool through their mobile platform and take a picture. The pic can be sent directly to a Cube or can be saved in the User's profile. Alternatively, the user can select a pic from a camera roll stored in the memory of the mobile device or on the cloud.

In another embodiment the cube cast page can include predetermined promotional pics on the 3D cube. These may be automatically selected for the user depending upon their like and interests as registered by the social media platform.

The Cube Cast page also includes a guided search page. As shown in FIG. 5B, the display may also include a search icon on the GUI. Selecting the search icon causes a search bar to appear. The user can facilitate s targeted search or a guided search.

In another embodiment, the social media platform senses a subsequent selection by a user. The selection may be touch-based or via a click of a mouse or trackball. If touch-based, the modification may be caused by a swipe of the GUI from left to right or right to left. The selection by the user modifies the current page on the GUI to show an Updates page or a Profile page. The Updates page includes options for displaying updates of other users that are associated with the user. The page may also include information of who is following the user. The page may also include information on which the user is following. In an exemplary embodiment, the Updates page includes all updated related to the user and their network.

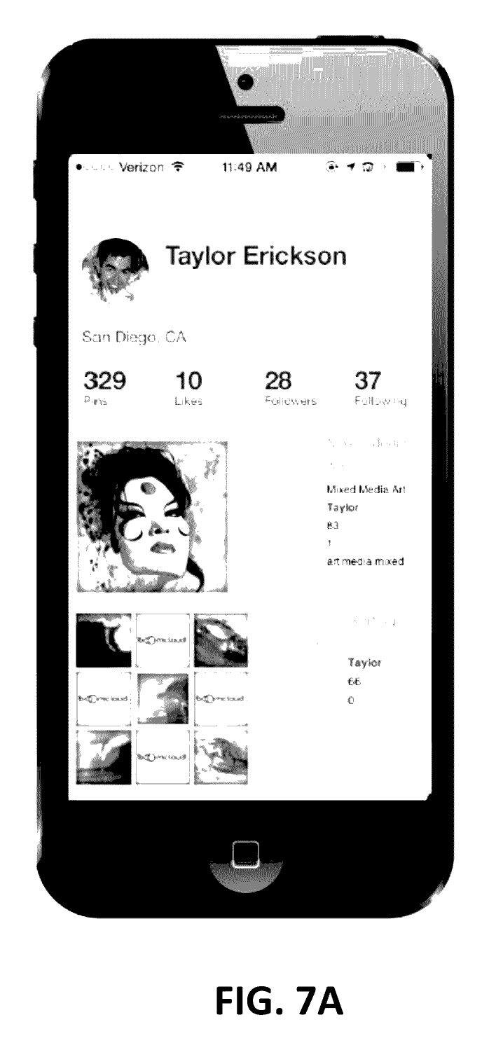

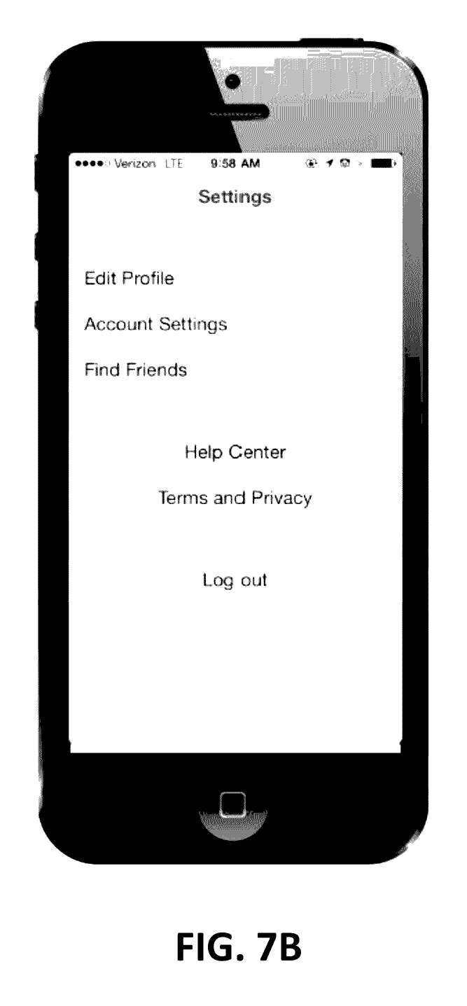

The modification could also result in a display of a Profile page of the GUI of the social media platform. For example, as shown in FIG. 7A, the Profile page can include details of the user's profile. The Profile page can also include metric details. The metrics can include statistical data for the total/aggregate user including but not limited to Pins, Likes, Followers, and Following information. As depicted in FIG. 7A, the user has 329 Pins, 10 Likes, 28 Followers and 37 users being followed. On a cube level, statistical data may include number of likes, number of clicks per cube, a heat map, number of clicks per tile. On a panel level, statistical data may at least include the number of likes.

In another embodiment, the statistical data may be provided for one or more accounts for the same user. For example, if the user includes different cubes, such as a professional 3D cube and a personal 3D cube, the metrics data would be provided for both cubes.

The Profile page also includes details for panel views as well as 3D cubes as a whole. Information for the panel views may include its Title, Description, Author, views, comments, likes, who is following, and tags.

According to another embodiment, the Profile page also includes a timeline of all 3D cubes and panels that the user has developed over a predetermined period. For instance, the user can go back in history and combine popular panels in the past with current, popular panels increase followers and visibility. Accordingly, all panels and cubes added and built by the user are available.

The Profile page also allows the user to mark their account as public or private. By default, the account is public. The security settings may be updated by the user under the Privacy settings.

In another embodiment, the Profile page also includes a Setting tab. As shown in FIG. 7B, the user can view the Terms and Conditions of the social media platform, change their Profile and/or Account settings, and review notification settings. The notification may include settings based upon the comfort level of the use. This may include when another user likes or comments the account holder's 3D cube or individual cubes. This may also include when another user like or comments on the account holder's panels. This may also include when another user mentions the account holder in a comment. This may also include when the account holder's cube is posted to a popular page. Further, this may include when the account holder is tagged in a photo/cube.

According to yet another embodiment, the account holder/user can find friends under the Profile page. The user can select the ‘Find Friends’ tab in the Settings menu to connect with friends through other social media platforms, e.g., Facebook. Alternatively, the user can import their contact list from their phone. Users may also search by name, username or by tags, e.g., #skydiving.

According to a further embodiment, a method for creating a cube is presented. Here, a third party, such as Boomcloud, or the user may opt to create the cube. The process of selecting which images to display on the cube is strategic and employs a determination of factors including but not limited to level of exposure desired, type of message to be conveyed, and risk/reward of diluting a message with too many images. If the user creates the cube, the user can upload the cube directly to a website capable of hosting the cube. This may performed via iframes or as a Web Component. Alternatively, if a third party creates the cube, the user is prompted to review and authorize the acceptability of the cube. Further, the cube is uploaded to a website. The website may be a personal website of the user. On the other hand, the website may be a social media platform in which the user wishes to exhibit its cube.

According to another aspect of the application, the 3D object may appear as a hologram image. The hologram may be touch-sensitive such that the user has the ability to alter the hologram image. For example, a selection of a tile of the 3D object may display the panel as a hologram image. In an embodiment, the user may rotate the hologram by touching a predetermined area proximate to or on the 3D object. For example, the proximate area may be a white space, e.g., border separating one face from another face of the 3D object. In so doing, the hologram of the 3D object is rotated to display another front forward face.

The image of the hologram may be classified as a transmittive type holography image or a reflective type holography image. According to the transmittive type holography image, the image is generated from light, and transmits a hologram if applied in a rear of the hologram. The image is observed in front of the hologram. For transmittive type holography images, an object wave and a reference wave are applied to a photo film in the same direction to generate a holography image.

According to the reflective type holography image, an image generated from light is reflected if applied in front of the hologram, and is observed in front of the hologram. For reflective type holography images, an object wave and a reference wave are incident on a photosensitive material in directions opposite to each other, respectively.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A computer-implemented method comprising:
displaying, on a display, a graphical user interface of a three-dimensional object having a face including a tile;
receiving, via a network, a selection of the tile of the three-dimensional object;
modifying, via the processor, three-dimensional object based upon the selected tile; and
displaying, on the display, a panel representative of the selected tile based upon the modification.

2. The method of claim 1, wherein the three-dimensional object is a cube.

3. The method of claim 2, wherein the face of the cube includes plural tiles.

4. The method of claim 1, wherein the panel displays an image selected from a picture, a webpage, another three-dimensional object, and combinations thereof.

5. The method of claim 1, further comprising;
detecting an input on the graphical user interface displaying a panel; and
modifying the graphical user interface to display a second panel associated with a second tile of the three-dimensional object.

6. The method of claim 5, wherein the second tile is associated with a second face of the three-dimensional object.

7. The method of claim 5, wherein the processor detects the input via a swiping action across the graphical user interface.

8. The method of claim 1, further comprising:
displaying, on the graphical user interface, profile or update information associated with the three-dimensional object.

9. The method of claim 8, wherein the profile information is selected from number of likes, number of followers, number of other users the user is following, number of views, number of likes of the three-dimensional object, number of likes of the face, number of likes of the tile, number of likes of the panel, frequency of clicks of the three-dimensional cube, frequency of clicks of the face, frequency of clicks of the tile, number of views of the three-dimensional object, number of views of the face, number of views of the tile, number of views of the panel, a timeline of all three-dimensional objects built by the user and combinations thereof.

10. The method of claim 8, wherein the update information is selected from updates associated with the user, updates of the three-dimensional object, updates of the user's network and combinations thereof.

11. The method of claim 1, further comprising:
receiving another selection from the user on an area of the graphical user interface bordering the face of three-dimensional object; and
rotating the three dimensional object such that a second face is displayed on the graphical user interface.

12. The method of claim 1, wherein the displayed three-dimensional object is a hologram.

13. A non-transitory computer readable medium comprising executable instructions, which when executed by a computer including a processor and a display, causes the computer to:
display, on the display, a graphical user interface of a three-dimensional cube exhibiting social media content, the three-dimensional cube having a face including a tile;
receive, via the graphical user interface, a selection of the tile including an aspect of the social media content; and
modify, via the processor, the three-dimensional cube based upon the selected tile.

14. The medium of claim 13, wherein the executable instructions further cause the computer to display, on the display, a panel representative of the selected tile after the modifying step.

15. A computer-implemented method for updating social media content comprising:
providing, on a display, a graphical user interface of a three-dimensional object exhibiting the social media content of a user on a network.
receiving, via the graphical user interface, a selection by the user of information associated with a second user on the network;
modifying the three-dimensional object to include the information on a tile of the three-dimensional object; and
displaying the modified three-dimensional object including the information on the tile.

16. The method of claim 15, further comprising:
adding the information of the second user to a profile page of the user before the modifying step.

17. The method of claim 15, further comprising:
sharing the modified three-dimensional object with the network.

18. The method of claim 15, wherein the social media content and the information are selected from pictures, webpages, videos, another three-dimensional object and combinations thereof.

19. The method of claim 15, further comprising;
detecting an input on the graphical user interface displaying a first panel associated with the tile of the modified three-dimensional object panel; and
updating the modified three-dimensional object to display a second panel associated with a second tile of the three-dimensional object.

20. The method of claim 19, wherein the second tile is associated with a second face of the modified three-dimensional object.
